(19) United States
(12) Patent Application Publication
(10) Pub. No.: US 2025/0316854 A1
(43) Pub. Date: Oct. 9, 2025

(54) BATTERY MODULE

(71) Applicant: SK ON CO., LTD., Seoul (KR)

(72) Inventor: Hoe Wook CHOI, Daejeon (KR)

(21) Appl. No.: 19/170,068

(22) Filed: Apr. 4, 2025

(30) Foreign Application Priority Data
Apr. 9, 2024 (KR) 10-2024-0048104

(51) Int. Cl. H01M 50/507; H01M 50/528; H01M 50/583

(52) U.S. Cl. CPC H01M 50/507; H01M 50/528; H01M 50/583

(57) ABSTRACT

According to an aspect of the present invention, there is provided a battery module including: a plurality of battery cells; a plurality of bus bars connected to the plurality of battery cells; a fuse assembly; and a bus bar connector configured to electrically connect the plurality of bus bars and the fuse assembly, wherein the fuse assembly may include: a fuse frame; a fuse connector coupled to the fuse frame and connected to the bus bar connector, and a plurality of fuse segments coupled to the fuse connector and electrically connected to the fuse connector.

### CROSS-REFERENCE TO RELATED APPLICATION

This patent application claims the priority and benefits of Korean patent application No. 10-2024-0048104, filed on Apr. 9, 2024, the disclosure of which is incorporated herein by reference in its entirety.

### BACKGROUND

### 1. Field of the Invention

The present disclosure relates to a battery module.

### 2. Description of the Related Art

A battery module may include fuses connected to bus bars. If a plurality of fuses are positioned adjacent to the bus bar, managing the battery module may become difficult in the event of a fuse failure.

### SUMMARY

An embodiment of the present disclosure is to provide a battery module that facilitates easy fuse replacement.

According to an aspect of the present invention, there is provided a battery module including: a plurality of battery cells; a plurality of bus bars connected to the plurality of battery cells; a fuse assembly; and a bus bar connector configured to electrically connect the plurality of bus bars and the fuse assembly, wherein the fuse assembly may include: a fuse frame; a fuse connector coupled to the fuse frame and connected to the bus bar connector; and a plurality of fuse segments coupled to the fuse connector and electrically connected to the fuse connector.

The bus bar connector may include: a bus bar connector head coupled to the fuse connector; a connector body which extends from the bus bar connector head; and a plurality of bus bar connector legs which branch out and extend from the connector body.

Each of the plurality of bus bar connector legs may include: a first bus bar connector leg end which extends from the connector body and is connected to a first connection bus bar among the plurality of bus bars; and a second bus bar connector leg end which extends from the connector body and is connected to a second connection bus bar among the plurality of bus bars.

Each of the plurality of bus bar connector legs may be electrically connected to a corresponding fuse segment of the plurality of fuse segments.

The number of the plurality of bus bar connector legs may be the same as the number of the plurality of fuse segments.

Each of the plurality of fuse segments may have a fuse function.

The battery module may further include: a lower case which includes a bottom case positioned below the plurality of battery cells; and an upper case which includes a top case positioned above the plurality of battery cells and is coupled to the lower case.

The battery module may further include a sensing frame which includes a sensing frame body positioned between the plurality of battery cells and the top case.

The sensing frame may further include a sensing frame coupler formed on the sensing frame body and coupled to the fuse frame.

The fuse assembly may be coupled to an upper surface of the sensing frame body, and the top case may include: a top case body positioned above the sensing frame; and a top case fuse opening formed in the top case body, in which the fuse assembly is positioned.

The battery module may further include a safety cap which is removably coupled to the top case body, and covers the fuse assembly.

The battery module may further include a battery sensor connected to the plurality of bus bars to acquire an electric signal and coupled to the sensing frame body.

The battery module may further include a sensing connector coupled to the upper surface of the sensing frame body and connected to the battery sensor, wherein the top case may further include a top case sensor opening formed in the top case body, in which the sensing connector is positioned.

The battery module may further include: a battery sensor connected to the plurality of bus bars to acquire an electric signal and coupled to the sensing frame body; and a sensing connector coupled to the upper surface of the sensing frame body and connected to the battery sensor, wherein the fuse frame may be connected to the sensing connector.

The fuse frame may be accommodated in a housing which forms an exterior of the sensing connector.

The top case may further include a top case sensor opening formed in the top case body, in which the sensing connector is positioned.

The fuse frame may be a circuit board, and may connect each of the plurality of fuse segments to the fuse connector.

Two bus bars, which are electrically isolated from the bus bar connector among the plurality of bus bars, may form a pair of external terminals connected to an external device.

According to an embodiment of the present disclosure, a battery module that facilitates easy fuse replacement may be provided.

The battery module of the present disclosure may be widely applied in green technology fields, such as electric vehicles, battery charging stations, as well as solar power generation, wind power generation, and the like, which use the batteries.

The battery module of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view illustrating a battery module 0 according to an embodiment of the present disclosure;

FIG. 2 is an exploded perspective view of the battery module shown in FIG. 1;

FIG. 3 is a perspective view illustrating a battery cell assembly shown in FIG. 2;

FIG. 4 is a perspective view illustrating a battery cell according to an embodiment of the present disclosure;

FIG. 5 is a view illustrating a cross-section of the battery cell shown in FIG. 4 taken on line A1-A2;

FIG. 6 is a perspective view illustrating a sensing frame according to an embodiment of the present disclosure;

FIG. 7 is a perspective view illustrating a fuse assembly according to an embodiment of the present disclosure;

FIG. 8 is a schematic view illustrating a bus bar connector according to an embodiment of the present disclosure;

FIG. 9 is a schematic view illustrating a state in which bus bars connected to the battery cell; and

FIG. 10 is a view illustrating a state in which bus bar connector legs are coupled to the bus bars shown in FIG. 9.

### DETAILED DESCRIPTION OF THE INVENTION

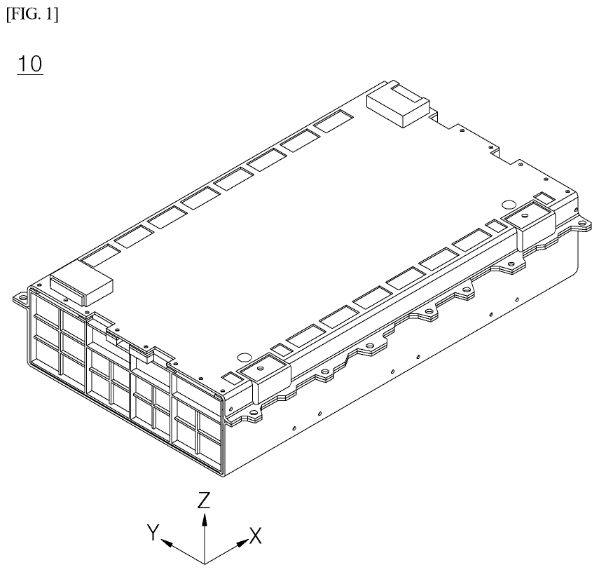

Hereinafter, embodiments of the present disclosure will be described in detail with reference to FIGS. 1 to 10. However, the embodiments are merely illustrative and the present disclosure is not limited to the specific embodiments described by way of example.

A battery module of the present disclosure may be applied to a pouch cell, a cylindrical cell, a square cell, etc. The electrode assembly 111 may be of a winding type, stacking type, z-folding type, or stack-folding type.

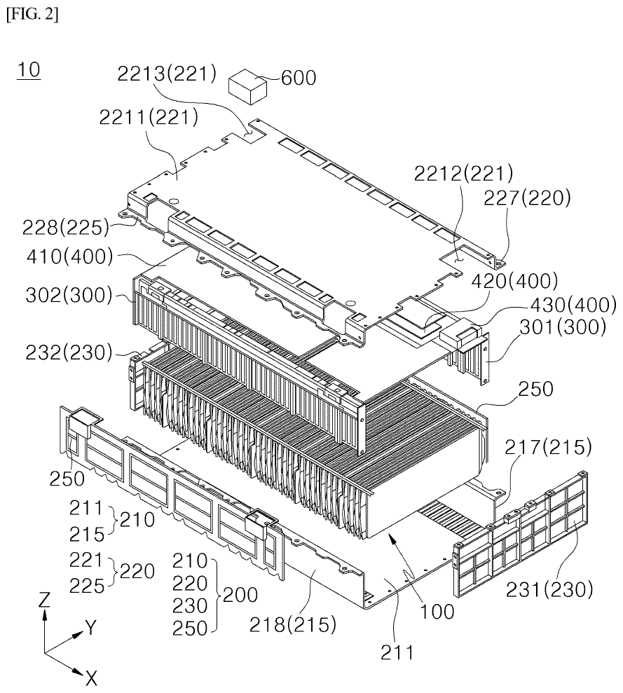

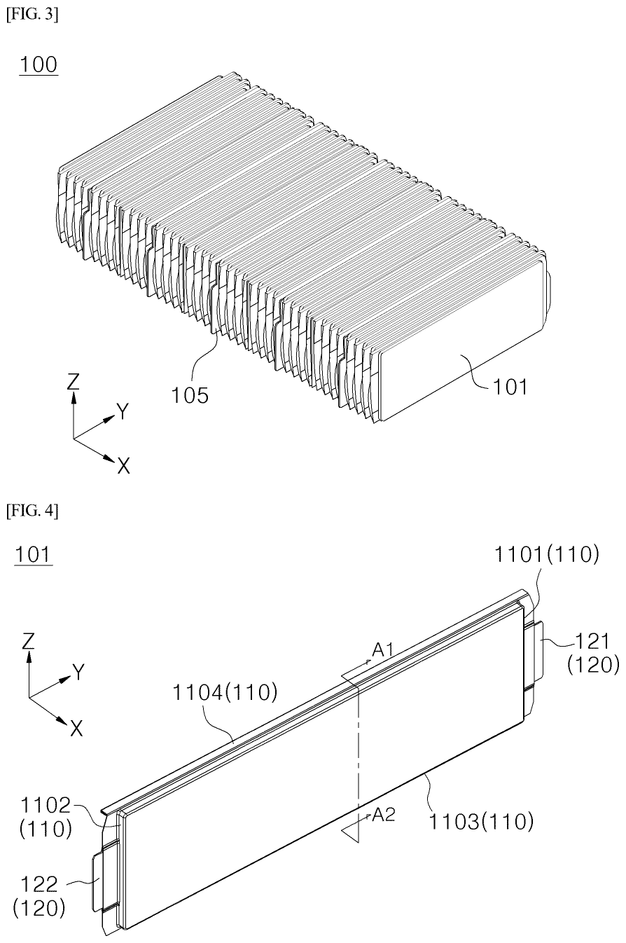

FIG. 1 is a view illustrating a battery module 10 according to an embodiment of the present disclosure. FIG. 2 is an exploded perspective view of the battery module 10 shown in FIG. 1. FIG. 3 is a view illustrating a battery cell assembly shown in FIG. 2.

In this specification, the coordinate system may be a Cartesian coordinate system. In this specification, the up-down direction and the front-back direction may be defined based on FIG. 2.

For example, the front-back direction may be parallel to an X-axis. For example, the positive X-axis direction may refer to the forward direction. For example, the negative X-axis direction may refer to rearward direction.

For example, the up-down direction may be parallel to a Z-axis. For example, the positive Z-axis direction may refer to the upward direction. For example, the negative Z-axis direction may refer to the downward direction.

For example, the left-right direction may be parallel to a Y-axis. For example, the positive Y-axis direction may refer to a left side (port side). For example, the negative Y-axis direction may refer to a right side (starboard side). The Y-axis may be perpendicular to the X-axis and the Z-axis, respectively.

Referring to FIGS. 1 to 3, the battery module 10 may include a battery cell assembly 100. The battery cell assembly 100 may include a plurality of battery cells 101. The plurality of battery cells 101 may be disposed or stacked in a single direction.

For example, the direction in which the plurality of battery cells 101 are disposed or stacked may correspond to a longitudinal direction or lengthwise direction of the battery module 10. The longitudinal direction of the battery module 10 may correspond to the front-back direction.

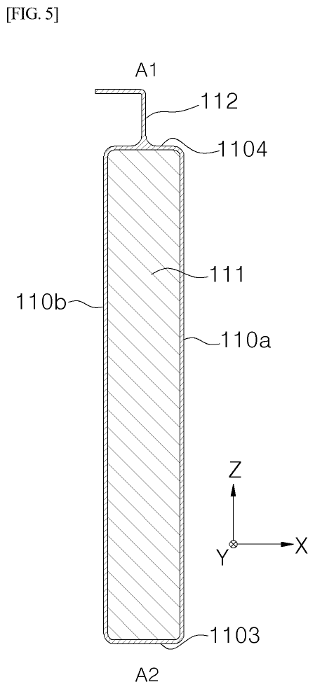

Each of the plurality of battery cells 101 may include a battery cell body 110 (see FIG. 4). The battery cell body 110 (see FIG. 4) may extend from one end to the other end. One end of the battery cell body 110 (see FIG. 4) may be referred to as a “first end” of the battery cell body 110 (see FIG. 4). The other end of the battery cell body 110 (see FIG. 4) may be referred to as a “second end” of the battery cell body 110 (see FIG. 4).

For example, the battery cell body 110 (see FIG. 4) may be formed in a shape extending in the width direction or the transverse direction of the battery module 10. In other words, the longitudinal direction or lengthwise direction of the battery cell body 110 (see FIG. 4) may correspond to the width direction or the transverse direction of the battery module 10.

Each of the plurality of battery cells 101 may include an electrode lead 120 (see FIG. 4). The electrode lead 120 (see FIG. 4) may be formed in a shape extending from the battery cell body 110 (see FIG. 4).

For example, the electrode lead 120 (see FIG. 4) may be formed in a shape extending from the battery cell body 110 (see FIG. 4). For example, the electrode lead 120 (see FIG. 4) may include a first electrode lead 121 (see FIG. 4) protruding from the first end of the battery cell body 110 (see FIG. 4). For example, the electrode lead 120 (see FIG. 4) may include a second electrode lead 122 (see FIG. 4) protruding from the second end of the battery cell body 110 (see FIG. 4).

The battery cell assembly 100 may include pads 105. The pads 105 may be positioned between the plurality of battery cells 101. When thermal runaway occurs in any one battery cell 101 of the plurality of battery cells 101, the pad 105 may suppress heat or flame from the battery cell 101 in which the thermal runaway has occurred from transmitting to the surrounding battery cells 101. The pad 105 may be made a heat-resistant material. In this context, the pad 105 may be referred to as a “thermal blocking pad.”

The battery module 10 may include a case 200. The case 200 may be referred to as a “battery case.” The case 200 may include a lower case 210. The lower case 210 may accommodate the battery cell assembly 100.

The lower case 210 may include a bottom case 211. The bottom case 211 may form a bottom of the case 200. The bottom case 211 may be positioned below the battery cell assembly 100.

In other words, the battery cell assembly 100 may be loaded on the bottom case 211. The bottom case 211 may be formed in a plate shape. The bottom case 211 may be referred to as a “bottom plate.”

The bottom plate 211 may include four edges. The four edges of the bottom plate 211 may define a perimeter of the bottom plate 211. Two connection edges of the bottom plate 211 may be the two edges extending in the longitudinal direction of the battery module 10 among the four edges of the bottom plate 211.

A “first connection edge” of the bottom plate 211 may be a connection edge adjacent to the first end of the battery cell body among the two connection edges of the bottom plate 211. The “first connection edge” of the bottom plate 211 may extend backward from one end of the front edge of the bottom plate 211 and connect to one end of the rear edge of the bottom plate 211.

The “second connection edge” of the bottom plate 211 may be a connection edge adjacent to the second end of the battery cell body among the two connection edges of the bottom plate 211. The “second connection edge” of the bottom plate 211 may extend backward from the other end of the front edge of the bottom plate 211 and connect to the other end of the rear edge of the bottom plate 211.

The first connection edge and the second connection edge of the bottom plate 211 may be parallel to each other.

The lower case 210 may include a side case 215. The side case 215 may be formed by extending upward from the bottom plate 211. The side case 215 may be formed integrally with the bottom plate 211.

A plurality of side case 215 may be provided. For example, the side case 215 may include a first side case 217 formed by extending upward from a first connection edge of the bottom plate 211.

For example, the side case 215 may include a second side case 218 formed by extending upward from a second connection edge of the bottom plate 211. The second side case 218 may face the first side case 217. The direction from the first side case 217 toward the second side case 218 may be parallel to the transverse direction of the battery module 10.

The case 200 may include an upper case 220. The upper case 220 may include a top case 221. The top case 221 may include a top case body 2211. The top case body 2211 may be made of a material including metal. The top case 221 may be referred to as a “top cover.”

The top case 221 may include an opening. For example, the top case 221 may include a top case sensor opening 2212. The top case sensor opening 2212 may be an opening formed in the top case body 2211. The sensing connector 430 may be positioned in the top case sensor opening 2212.

For example, the top case 221 may include a top case fuse opening 2213. The top case fuse opening 2213 may be an opening formed in the top case body 2211. A fuse assembly 500 (see FIG. 7) may be positioned in the top case fuse opening 2213.

The top case 221 may include four edges (or sides). The four edges of the top case 221 may define a perimeter of the top case 221. The two connection edges (or connection sides) of the top case 221 may be two sides extending in the longitudinal direction of the battery module 10 among the four edges of the top case 221.

The “first connection edge” of the top case 221 may be a connection edge adjacent to the first end of the battery cell body 110 among the two connection edges of the top case 221. The “second connection edge” of the top case 221 may be a connection edge adjacent to the second end of the battery cell body 110 among the two connection edges of the top case 221. The first connection edge and the second connection edge may be parallel to each other.

The upper case 220 may include a wing case 225. The wing case 225 may be formed integrally with the top case 221. The wing case 225 may be formed by extending downward from an edge of the top case 221.

For example, the wing case 225 may include a first wing case 227 formed by extending downward from a first connection edge of the top case 221. For example, the wing case 225 may include a second wing case 228 formed by extending downward from a second connection edge of the top case 221.

The wing case 225 may be coupled or fastened to the side case 215. For example, the first wing case 227 may be coupled or fastened to the first side case 217. For example, the second wing case 228 may be coupled or fastened to the second side case 218.

The case 200 may include front and rear case 230. The front and rear case 230 may include a front case 231. The front case 231 may face the battery cell assembly 100. The front case 231 may be positioned in front of the battery cell assembly 100.

The front case 231 may be connected or coupled to a front end of the first side case 217. The front case 231 may be connected or coupled to a front end of the second side case 218. The front case 231 may be connected or coupled to the front end of the bottom case 217. The front case 231 may be referred to as a “first cover plate.”

The front and rear case 230 may include a rear case 232. The rear case 232 may face the battery cell assembly 100. The rear case 232 may be positioned behind the battery cell assembly 100.

The rear case 232 may be connected or coupled to a rear end of the first side case 217. The rear case 232 may be connected or coupled to a rear end of the second side case 218. The rear case 232 may be connected or coupled to the rear end of the bottom case 217. The rear case 232 may be referred to as a “second cover plate.”

The front and rear case 230 may be referred to as a “cover plate.” The cover plate 230 may refer to at least one of the first cover plate 231 and the second cover plate 232.

The case 200 may include an insulation cover 250. The insulation cover 250 may be disposed between the battery cell assembly 100 and the side case 215. The insulation cover 250 may be made of an insulation material.

The battery module 10 may include a bus bar unit 300. The bus bar unit 300 may be electrically connected to the battery cell assembly 100. The bus bar unit 300 may be disposed between the battery cell assembly 100 and the case 200. The bus bar unit 300 may electrically connect the plurality of battery cells 101. A plurality of bus bar unit 300 may be provided.

For example, the bus bar unit 300 may include a first bus bar unit 301 disposed between the first side case 217 and the battery cell assembly 100. The first bus bar unit 301 may electrically connect first electrode leads 121 (see FIG. 4) of the plurality of battery cells 101.

For example, the bus bar unit 300 may include a second bus bar unit 302 disposed between the second side case 218 and the battery cell assembly 100. The second bus bar unit 302 may electrically connect second electrode leads 122 (see FIG. 4) of the plurality of battery cells 101.

The battery module 10 may include a sensing unit 400. The sensing unit 400 may include a sensing frame 410. The sensing frame 410 may connect the first bus bar unit 301 and the second bus bar unit 302.

The sensing frame 410 may be positioned between the battery cell assembly 100 and the top case 221. The sensing frame 410 may be formed in a plate or board shape.

The sensing unit 400 may include a battery sensor 420. The battery sensor 420 may be connected or fixed to the sensing frame 410. The battery sensor 420 may be connected to the bus bar unit 300.

For example, the battery sensor 420 may be electrically connected to the bus bar unit 300. For example, the battery sensor 420 may be electrically connected to the first bus bar unit 301 and to the second bus bar unit 302.

For example, the battery sensor 420 may acquire a signal from the bus bar unit 300. For example, the battery sensor 420 may acquire an electrical signal from the bus bar unit 300. The electrical signal acquired by the battery sensor 420 may be a current or a voltage. Accordingly, the battery sensor 420 may acquire information about a charging and discharging state of the battery cell assembly 100.

For example, the battery sensor 420 may include a temperature sensor. For example, the temperature sensor included in the battery sensor 420 may acquire temperature information of the battery cell assembly 100.

The sensing unit 400 may include a sensing connector 430. The sensing connector 430 may be coupled or connected to the sensing frame 410. For example, the sensing connector 430 may be positioned on an upper surface of the sensing frame 410. The sensing connector 430 may be positioned in the top case sensor opening 2212.

The sensing connector 430 may be connected to the battery sensor 420. The sensing connector 430 may be connected to an external device. For example, the sensing connector 430 may be connected to a battery management system (BMS). For example, the sensing connector 430 may transmit information about the battery cell assembly 100 to the BMS. The information about the battery cell assembly 100 may include at least one of information about the charging and discharging state of the battery cell assembly 100 and information about a temperature of the battery cell assembly 100.

The battery module 10 may include a safety cap 600. The safety cap 600 may cover the top case fuse opening 2213. For example, the safety cap 600 may be positioned over the top case fuse opening 2213.

For example, the safety cap 600 may cover the fuse assembly 500 (see FIG. 7) positioned in the top case fuse opening 2213. The safety cap 600 may be coupled to the top case body 2211. For example, the safety cap 600 may be removably coupled to the top case body 2211.

The safety cap 600 may be rigid. For example, the safety cap 600 may protect the fuse assembly 500 (see FIG. 7) from external impacts. For example, the safety cap 600 may be made of a material including at least one of a polymer and a metal. For example, the safety cap 600 may be made of reinforced plastic. FIG. 4 is a view illustrating the battery cell according to an embodiment of the present disclosure. FIG. 5 is a view illustrating a cross-section of the battery cell shown in FIG. 4 taken on line A1-A2.

Referring to FIG. 4 and FIG. 5, the battery cell assembly 100 (see FIG. 3) may include the plurality of battery cells 101. The battery cell 101 may include the battery cell body 110.

The battery cell body 110 may be formed in an extended or elongated shape in the lengthwise direction of the battery cell body 110. For example, the lengthwise direction of the battery cell body 110 may correspond to the width direction of the battery module 10.

The battery cell body 110 may define a thickness direction. For example, the thickness direction of the battery cell body 110 may correspond to the thickness direction of the battery cell 101. For example, the thickness direction of the battery cell body 110 may correspond to the direction in which the plurality of battery cells 101 are stacked.

For example, the thickness direction of the battery cell body 110 may correspond to the front-back direction. For example, the thickness direction of the battery cell body 110 may correspond to the lengthwise direction or the longitudinal direction of the battery module 10 (see FIGS. 1 and 2).

The battery cell body 110 may have two sides defined in the thickness direction. For example, the battery cell body 110 may include a cell body front surface 110a and a cell body rear surface 110b.

The cell body front surface 110a may define the front surface of the battery cell body 110. The cell body rear surface 110b may define the rear surface of the battery cell body 110. In the adjacent two battery cells 101, the cell body front surface 110a of the rear battery cell 101 may face or abut the cell body rear surface 110b of the front battery cell 101.

The battery cell body 110 may define a perimeter. For example, a face or surface having a width equal to the thickness of the battery cell body 110 may be formed along the perimeter of the battery cell body 110. The thickness direction of the battery cell body 110 may be parallel to the direction in which the plurality of battery cells 101 are stacked.

For example, the battery cell body 110 may include a lower cell body edge face 1103, which defines a lower surface of the battery cell body 110. The lower cell body edge face 1103 may be elongated along a lower side or edge of the battery cell body 110. The width of the lower cell body edge face 1103 may correspond to the thickness of the battery cell body 110. The lower cell body edge face 1103 may face or abut the bottom case 211.

For example, the battery cell body 110 may include an upper cell body edge face 1104, which defines an upper surface of the battery cell body 110. The upper cell body edge face 1104 may be elongated along an upper side of the battery cell body 110. The width of the upper cell body edge face 1104 may correspond to the thickness of the battery cell body 110. The upper cell body edge face 1104 may face or abut the top case 221.

For example, the battery cell body 110 may include a first cell body edge face 1101 disposed to face the first bus bar unit 301 (see FIG. 2). The first cell body edge face 1101 may extend upward from a first end of the lower cell body edge face 1103 to a first end of the upper cell body edge face 1104. The width of the first cell body edge face 1101 may correspond to the thickness of the battery cell body 110.

For example, the battery cell body 110 may include a second cell body edge face 1102 disposed to face the second bus bar unit 302 (see FIG. 2). The second cell body edge face 1102 may extend upward from a second end of the lower cell body edge face 1103 to a second end of the upper cell body edge face 1104. The width of the second cell body edge face 1102 may correspond to the thickness of the battery cell body 110.

The battery cell 101 may include an electrode assembly 111. The electrode assembly 111 may be a portion of the battery cell body 110. The electrode assembly 111 may be referred to as a “jelly-roll.”

The battery cell 101 may include an exterior material 112. The exterior material 112 may include, for example, a pouch in the shape of a sheet. The exterior material 112 may accommodate the electrode assembly 111. For example, the exterior material 112 may be sealed to accommodate the electrode assembly 111 therein. The exterior material 112 may be another portion of the battery cell body 110.

The battery cell 101 may include the electrode lead 120. The electrode lead 120 may extend from the electrode assembly 111. The electrode lead 120 may protrude from the battery cell body 110. For example, at least a portion of the electrode lead 120 may be wrapped by an exterior material 112.

The electrode lead 120 may protrude in the lengthwise direction of the battery cell body 110. For example, the electrode lead 120 may include the first electrode lead 121 protruding from the first cell body edge face 1101 of the battery cell body 110. For example, the electrode lead 120 may include the second electrode lead 122 protruding from the second cell body edge face 1102 of the battery cell body 110.

The lengthwise direction of the battery cell body 110 may be parallel to the direction from the first electrode lead 121 toward the second electrode lead 122. The lengthwise direction of the battery cell body 110 may be parallel to the direction from the first cell body edge face 1101 toward the first cell body edge face 1102. The lengthwise direction of the battery cell 101 may correspond to the lengthwise direction of the battery cell body 110.

The width direction of the battery cell body 110 may be parallel to the direction from the lower cell body edge face 1103 toward the upper cell body edge face 1104. The width direction of the battery cell body 110 may correspond to the up-down direction. The width direction of the battery cell 101 may correspond to the width direction of the battery cell body 110.

The thickness direction of the battery cell body 110 may be parallel to the direction from the cell body front surface 110a toward the cell body rear surface 110b. The thickness direction of the battery cell 101 may correspond to the thickness direction of the battery cell body 110.

In an unfolded state, the exterior material 112 may define two sides. For example, the exterior material 112 may define an inner side surface of the exterior material and an outer side surface of the exterior material. When the exterior material 112 accommodates and seals the electrode assembly 111, the inner surface of the exterior material 112 may face the electrode assembly 111 while the outer surface of the exterior material 112 may define an outer surface of the battery cell body 110.

In the unfolded state, the exterior material 112 may define a housing part that accommodates the electrode assembly 111.

For example, the housing part of the exterior material 112 may include a front housing part that accommodates a front portion of the electrode assembly 111. The front housing part of the exterior material 112 may define the cell body front surface 110a.

For example, the housing part of the exterior material 112 may include a rear housing part that accommodates a rear portion of the electrode assembly 111. The rear housing part of the exterior material 112 may define the cell body rear surface 110b.

The lower cell body edge face 1103 may connect the cell body front surface 110a and the cell body rear surface 110b. The lower cell body edge face 1103 may connect the front housing part and the rear housing part of the exterior material 112. The lower cell body edge face 1103 of the exterior material 112 may connect the front housing part and the rear housing part of the exterior material 112. In this context, the lower cell body edge face 1103 of the exterior material 112 may be referred to as a “connection part.”

The lower cell body edge face 1103 of the exterior material 112 may face and abut the electrode assembly 111. For example, an inner surface of the lower cell body edge face 1103 of the exterior material 112 may face and abut the electrode assembly 111. For example, an outer surface of the lower cell body edge face 1103 of the exterior material 112 may face and abut the bottom case 211 (see FIG. 2).

At least one of the upper cell body edge face 1103, the first cell body edge face 1101 and the second cell body edge face 1102 of the exterior material 112 may be formed by overlapping and attaching sheets that make up the exterior material 112.

Therefore, at the upper cell body edge face 1103, the first cell body edge face 1101 and the second cell body edge face 1102, the exterior material 112 may protrude outward from the battery cell body 110.

For this reason, the effect (or efficiency) of cooling the battery cell body 110 at the lower cell body edge face 1103 may be greater than the effect (or efficiency) of cooling the battery cell body 110 at at least one of the upper cell body edge face 1103, the first cell body edge face 1101 and the second cell body edge face 1102.

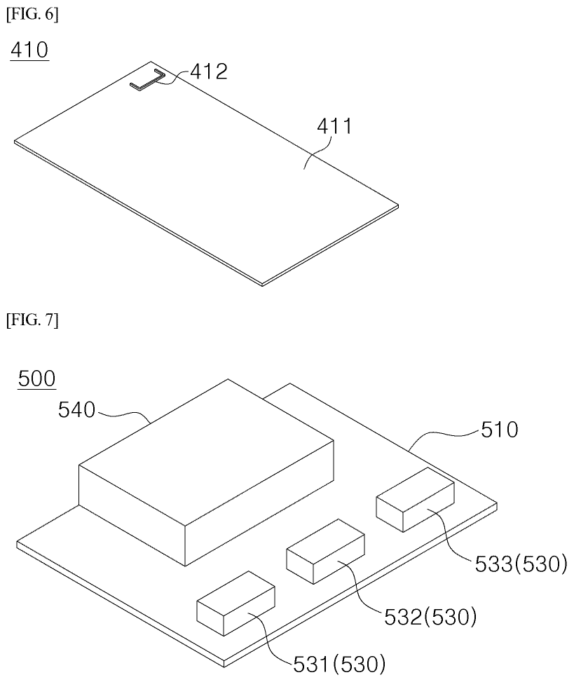

FIG. 6 is a view illustrating the sensing frame 410 according to an embodiment of the present disclosure.

Referring to FIG. 6, the sensing frame 410 may include a sensing frame body 411. The sensing frame body 411 may be formed in a plate or board shape.

For example, the sensing frame body 411 may have an upper surface and a lower surface on both sides. For example, the upper surface of the sensing frame body 411 may face or be opposite to the top case 221. For example, the lower surface of the sensing frame body 411 may face or be opposite to the battery cell assembly 100.

The sensing frame 410 may include a sensing frame coupler 412. The sensing frame coupler 412 may be formed, connected, or coupled to the sensing frame body 411. For example, the sensing frame coupler 412 may be positioned on an upper surface of the sensing frame body 411.

For example, the sensing frame coupler 412 may be formed in a shape protruding from the upper surface of the sensing frame body 411. For another example, the sensing frame coupler 412 may be formed in a recessed shape on the upper surface of the sensing frame body 411.

The sensing frame coupler 412 may be coupled to the fuse assembly 500 (see FIG. 7). For example, the fuse assembly 500 (see FIG. 7) may be removably coupled to the sensing frame coupler 412.

For example, the fuse assembly 500 (see FIG. 7) may be mounted on the sensing frame coupler 412. For example, the fuse assembly 500 (see FIG. 7) may be positioned on the upper surface of the sensing frame body 411 and fixed to the sensing frame coupler 412.

FIG. 7 is a view illustrating the fuse assembly according to an embodiment of the present disclosure.

Referring to FIG. 7, the battery module 10 (see FIG. 2) may include the fuse assembly 500. The fuse assembly 500 may include the fuse frame 510.

The fuse frame 510 may be formed in a board or plate shape. For example, the fuse frame 510 may have an upper surface and a lower surface on both sides.

For example, the fuse frame 510 may include a circuit board. For example, the fuse frame 510 may include a printed circuit board (PCB). For example, the fuse frame 510, as a circuit board, is configured to connect each of the plurality of fuse segments 530 to the fuse connector 540.

The fuse frame 510 may be connected, coupled or fixed to the sensing frame 410 (see FIG. 6). For example, the lower surface of the fuse frame 510 may be positioned on the upper surface of the sensing frame body 411 (see FIG. 6). For example, the fuse frame 510 may be coupled or connected to the sensing frame coupler 412 (see FIG. 6).

For example, the fuse frame 510 may be connected or coupled to the sensing connector 430 (see FIG. 2). In this case, the fuse assembly 500 may be connected or coupled to the sensing frame 410 (see FIG. 6) without the top case fuse opening 2213 (see FIG. 2) and the safety cap 600.

For example, the fuse frame 510 may be accommodated in the sensing connector 430 (see FIG. 2). For example, the fuse assembly 500 may be accommodated in a housing which forms an exterior of the sensing connector 430 (see FIG. 2).

The fuse assembly 500 may include a fuse segment 530. The fuse segment 530 may be mounted, connected, coupled or fixed to the fuse frame 510. For example, the fuse segment 530 may be positioned on an upper surface of the fuse frame 510.

The fuse segment 530 may be electrically connected to the fuse frame 510. For example, the fuse segment 530 may include two terminals that are electrically connected to the fuse frame 510.

A plurality of fuse segment 530 may be provided. For example, the fuse assembly 500 may include the plurality of fuse segments 530. For example, the fuse assembly 500 may include a first fuse segment 531, a second fuse segment (532) and a third fuse segment 533.

The fuse segment 530 may refer to each of the plurality of fuse segments 530. For example, the fuse segment 530 may include or refer to at least one of the first fuse segment 531, the second fuse segment 532 and the third fuse segment 533.

The fuse segment 530 may have electric resistance or impedance. For example, electric current may flow through the fuse segment 530 or electric voltage may be applied thereto.

The fuse segment 530 may perform the function of a fuse. For example, if current flowing through the fuse segment 530 reaches or exceeds the upper limit current, the circuit formed in the fuse segment 530 may switch to an open state.

The fuse assembly 500 may include a fuse connector 540. The fuse connector 540 may be connected, coupled or fixed to the fuse frame 510. For example, the fuse connector 540 may be positioned on the upper surface of the fuse frame 510.

The fuse connector 540 may be electrically connected to the fuse frame 510. For example, the fuse frame 510 may electrically connect the fuse connector 540 and the fuse segment 530.

For example, a conductive wire formed on the fuse frame 510 may electrically connect the fuse connector 540 and the fuse segment 530. The conductive wire may be formed on one surface of the fuse frame 510.

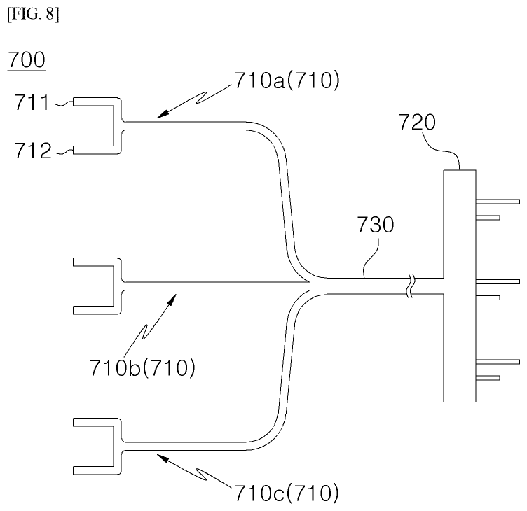

FIG. 8 is a schematic view illustrating the bus bar connector according to an embodiment of the present disclosure.

Referring to FIG. 8, the battery module 10 (see FIG. 2) may include a bus bar connector 700. The bus bar connector 700 may include a bus bar connector leg 710.

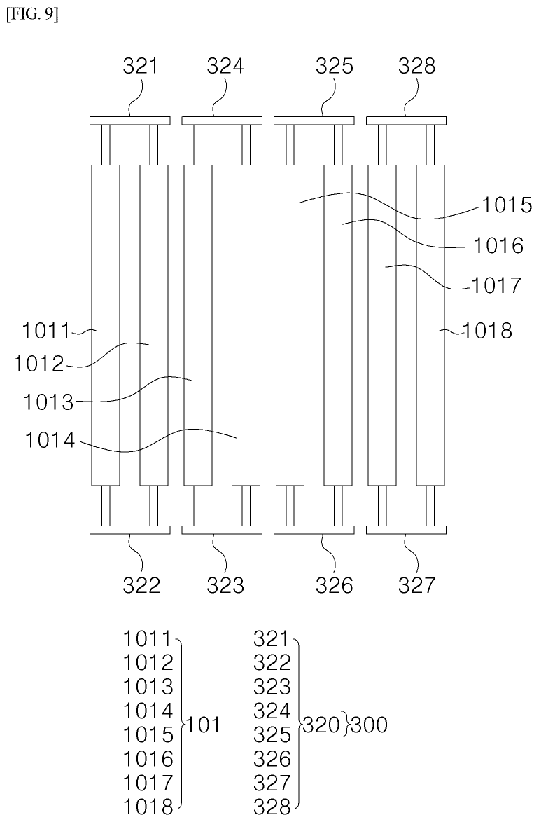

The bus bar connector leg 710 may be connected or coupled to the bus bar unit 300 (see FIG. 2). For example, the bus bar connector leg 710 may be connected or coupled to a bus bar 320 (see FIG. 9). For example, the bus bar connector leg 710 may be electrically connected to the bus bar 320 (see FIG. 9).

A plurality of bus bar connector legs 710 may be provided. For example, the bus bar connector 700 may include the plurality of bus bar connector legs 710.

For example, the bus bar connector 700 may include a first bus bar connector leg 710a, a second bus bar connector leg 710b, and a third bus bar connector leg 710c.

The bus bar connector leg 710 may include or refer to at least one of the first bus bar connector leg 710a, the second bus bar connector leg 710b, and the third bus bar connector leg 710c.

The bus bar connector leg 710 may include a first bus bar connector leg end 711 and a second bus bar connector leg end 712. The bus bar connector leg ends 711 and 712 may include or refer to the first bus bar connector leg end 711 and the second bus bar connector leg end 712. The bus bar connector leg ends 711 and 712 may be connected or coupled to the bus bar 320 (see FIG. 9).

For example, the first bus bar connector leg end 711 may be connected or coupled to one of the plurality of bus bars 320 (see FIG. 9). The bus bar 320 (see FIG. 9) connected to the first bus bar connector leg end 711 among the plurality of bus bars 320 (see FIG. 9) may be referred to as a “first connection bus bar.”

For example, the second bus bar connector leg end 712 may be connected or coupled to one of the plurality of bus bars 320 (see FIG. 9). The bus bar 320 (see FIG. 9) connected to the second bus bar connector leg end 712 among the plurality of bus bars 320 (see FIG. 9) may be referred to as a “second connection bus bar.” The first connection bus bar 320 (see FIG. 9) and the second connection bus bar 320 (see FIG. 9) may be adjacent or positioned next to each other.

The bus bar connector 700 may include a bus bar connector head 720. The bus bar connector head 720 may be coupled to the fuse connector 540 (see FIG. 7). For example, the bus bar connector head 720 may be electrically connected to the fuse connector 540 (see FIG. 7).

The bus bar connector 700 may include a bus bar connector body 730. The bus bar connector body 730 may connect the bus bar connector leg 710 and the bus bar connector head 720. For example, the plurality of bus bar connector legs 710 may branch out and extend from the bus bar connector body 730.

For example, one end of the bus bar connector body 730 may be connected to the bus bar connector leg 710, and the other end of the bus bar connector body 730 may be connected to the bus bar connector head 720.

FIG. 9 is a schematic view illustrating a state in which the bus bars are connected to the battery cell.

Referring to FIG. 9, the bus bar unit 300 may include the bus bar 320. For example, a plurality of bus bar 320 may be provided. For example, the bus bar unit 300 may include a first bus bar 321, a second bus bar 322, a third bus bar 323, a fourth bus bar 324, a fifth bus bar 325, a sixth bus bar 326, a seventh bus bar 327, and an eighth bus bar 328.

The bus bar 320 may include or refer to at least one of a plurality of bus bars 320. For example, the bus bar 320 of the bus bar unit 300 may include or refer to at least one of the first bus bar 321, the second bus bar 322, the third bus bar 323, the fourth bus bar 324, the fifth bus bar 325, the sixth bus bar 326, the seventh bus bar 327, and the eighth bus bar 328.

The plurality of battery cells 101 may be provided. For example, the battery cell assembly 100 (see FIG. 3) may include the plurality of battery cells 101. For example, the battery cell assembly 100 (see FIG. 3) may include a first battery cell 1011, a second battery cell 1012, a third battery cell 1013, a fourth battery cell 1014, a fifth battery cell 1015, a sixth battery cell 1016, a seventh battery cell 1017, and an eighth battery cell 1018.

The battery cell 101 may include or refer to at least one of the plurality of battery cells 101. For example, the battery cell 101 may include or refer to at least one of the first battery cell 1011, the second battery cell 1012, the third battery cell 1013, the fourth battery cell 1014, the fifth battery cell 1015, the sixth battery cell 1016, the seventh battery cell 1017, and the eighth battery cell 1018.

The battery cell 101 may be connected or coupled to the bus bar 320. For example, the electrode lead 120 (see FIG. 4) of the battery cell 101 may be connected or coupled to the bus bar 320.

For example, the first bus bar 321 may be coupled to the first electrode lead 121 (see FIG. 4) of the first battery cell 1011 and the first electrode lead 121 (see FIG. 4) of the second battery cell 1012.

For example, the second bus bar 322 may be coupled to the second electrode lead 122 (see FIG. 4) of the first battery cell 1011 and the second electrode lead 122 (see FIG. 4) of the second battery cell 1012.

For example, the third bus bar 323 may be coupled to the second electrode lead 122 of the third battery cell 1013 (see FIG. 4) and the second electrode lead 122 of the fourth battery cell 1014 (see FIG. 4).

For example, the fourth bus bar 324 may be coupled to the first electrode lead 121 of the third battery cell 1013 (see FIG. 4) and the first electrode lead 121 of the fourth battery cell 1014 (see FIG. 4).

For example, the fifth bus bar 325 may be coupled to the first electrode lead 121 of the fifth battery cell 1015 (see FIG. 4) and the first electrode lead 121 of the sixth battery cell 1016 (see FIG. 4).

For example, the sixth bus bar 326 may be coupled to the second electrode lead 122 of the fifth battery cell 1015 (see FIG. 4) and the second electrode lead 122 of the sixth battery cell 1016 (see FIG. 4).

For example, the seventh bus bar 327 may be coupled to the second electrode lead 122 of the seventh battery cell 1017 (see FIG. 4) and the second electrode lead 122 of the eighth battery cell 1018 (see FIG. 4).

For example, the eighth bus bar 328 may be coupled to the first electrode lead 121 of the seventh battery cell 1017 (see FIG. 4) and the first electrode lead 121 of the eighth battery cell 1018 (see FIG. 4).

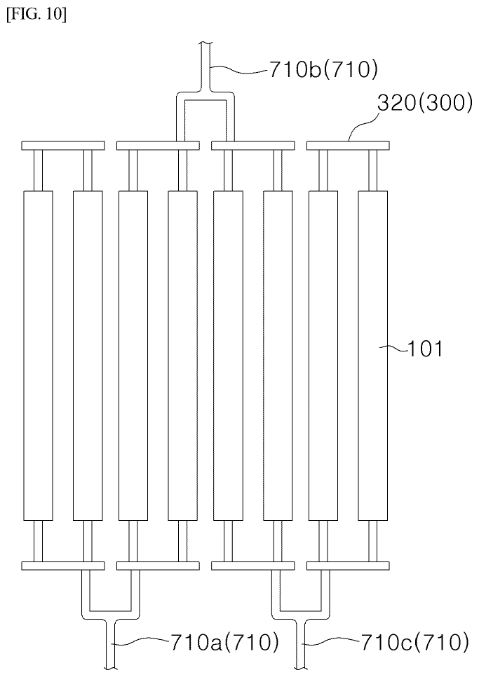

FIG. 10 is a view illustrating a state in which the bus bar connector legs are coupled to the bus bars shown in FIG. 9.

Referring to FIGS. 8 to 10, the bus bar connector leg 710 may be connected or coupled to the bus bar 320. For example, the bus bar connector leg 710 may be electrically connected to two adjacent bus bars 320.

The second bus bar 322 may be connected to the first bus bar connector leg end 711 of the first bus bar connector leg 710a. The first bus bar connector leg end 711 of the first bus bar connector leg 710a may be electrically connected to the first fuse segment 531 through the bus bar connector body 730 and the bus bar connector head 720.

The third bus bar 323 may be connected to the second bus bar connector leg end 712 of the first bus bar connector leg 710a. The second bus bar connector leg end 712 of the first bus bar connector leg 710a may be electrically connected to the first fuse segment 531 through the bus bar connector body 730 and the bus bar connector head 720.

For example, the second bus bar 322, the first fuse segment 531, and the third bus bar 323 may be electrically connected in sequence to form an electrical circuit.

The fourth bus bar 324 may be connected to the first bus bar connector leg end 711 of the second bus bar connector leg 710b. The first bus bar connector leg end 711 of the second bus bar connector leg 710b may be electrically connected to the second fuse segment 532 through the bus bar connector body 730 and the bus bar connector head 720.

The fifth bus bar 325 may be connected to the second bus bar connector leg end 712 of the second bus bar connector leg 710b. The second bus bar connector leg end 712 of the second bus bar connector leg 710b may be electrically connected to the second fuse segment 532 through the bus bar connector body 730 and the bus bar connector head 720.

For example, the fourth bus bar 324, the second fuse segment 532, and the fifth bus bar 325 may be electrically connected in sequence to form an electrical circuit.

The sixth bus bar 326 may be connected to the first bus bar connector leg end 711 of the third bus bar connector leg 710c. The first bus bar connector leg end 711 of the third bus bar connector leg 710c may be electrically connected to the third fuse segment 533 through the bus bar connector body 730 and the bus bar connector head 720.

The seventh bus bar 327 may be connected to the second bus bar connector leg end 712 of the third bus bar connector leg 710c. The second bus bar connector leg end 712 of the third bus bar connector leg 710c may be electrically connected to the third fuse segment 533 through the bus bar connector body 730 and the bus bar connector head 720.

For example, the sixth bus bar 326, the third fuse segment 533, and the seventh bus bar 327 may be electrically connected in sequence to form an electrical circuit.

The first bus bar 321 and the eighth bus bar 328 may not be connected to the bus bar connector leg 710. For example, the first bus bar 321 and the eighth bus bar 328 may be electrically isolated from the bus bar connector 700.

The first bus bar 321 and the eighth bus bar 328 may form two external terminals of the battery module 10 (see FIG. 2). The first bus bar 321 and the eighth bus bar 328 may be connected to an external device. That is, the first bus bar 321 and the eighth bus bar 328 may form a “pair of external terminals.”

The two terminals of the battery module 10 (see FIG. 2) may be connected to the external terminal to provide power to the external terminal. The two terminals of the battery module 10 (see FIG. 2) may be connected to the external terminal to be charged.

Referring to FIGS. 1 to 10, the number of the plurality of bus bar connector legs 710 may be the same as the number of the plurality of fuse segments 530.

The contents described above are merely an example of applying the principle of the present disclosure, and other configurations may be further included without departing from the scope of the present invention.

What is claimed is:

1. A battery module comprising:
a plurality of battery cells;
a plurality of bus bars connected to the plurality of battery cells;
a fuse assembly; and
a bus bar connector configured to electrically connect the plurality of bus bars and the fuse assembly,
wherein the fuse assembly comprises:
a fuse frame;
a fuse connector coupled to the fuse frame and connected to the bus bar connector; and
a plurality of fuse segments coupled to the fuse connector and electrically connected to the fuse connector.

2. The battery module according to claim 1, wherein the bus bar connector comprises:
a bus bar connector head coupled to the fuse connector;
a connector body which extends from the bus bar connector head; and
a plurality of bus bar connector legs which branch out and extend from the connector body.

3. The battery module according to claim 2, wherein each of the plurality of bus bar connector legs comprises:
a first bus bar connector leg end which extends from the connector body and is connected to a first connection bus bar among the plurality of bus bars; and
a second bus bar connector leg end which extends from the connector body and is connected to a second connection bus bar among the plurality of bus bars.

4. The battery module according to claim 2, wherein each of the plurality of bus bar connector legs is electrically connected to a corresponding fuse segment of the plurality of fuse segments.

5. The battery module according to claim 4, wherein the number of the plurality of bus bar connector legs is the same as the number of the plurality of fuse segments.

6. The battery module according to claim 1, wherein each of the plurality of fuse segments has a fuse function.

7. The battery module according to claim 1, further comprising:
a lower case which includes a bottom case positioned below the plurality of battery cells; and
an upper case which includes a top case positioned above the plurality of battery cells and is coupled to the lower case.

8. The battery module according to claim 7, further comprising a sensing frame which includes a sensing frame body positioned between the plurality of battery cells and the top case.

9. The battery module according to claim 8, wherein the sensing frame further comprises a sensing frame coupler formed on the sensing frame body and coupled to the fuse frame.

10. The battery module according to claim 8, wherein the fuse assembly is coupled to an upper surface of the sensing frame body, and
the top case comprises:
a top case body positioned above the sensing frame; and
a top case fuse opening formed in the top case body, in which the fuse assembly is positioned.

11. The battery module according to claim 10, further comprising a safety cap which is removably coupled to the top case body, and covers the fuse assembly.

12. The battery module according to claim 10, further comprising a battery sensor connected to the plurality of bus bars to acquire an electric signal and coupled to the sensing frame body.

13. The battery module according to claim 12, further comprising a sensing connector coupled to the upper surface of the sensing frame body and connected to the battery sensor,
wherein the top case further comprises a top case sensor opening formed in the top case body, in which the sensing connector is positioned.

14. The battery module according to claim 8, further comprising:
a battery sensor connected to the plurality of bus bars to acquire an electric signal and coupled to the sensing frame body; and
a sensing connector coupled to the upper surface of the sensing frame body and connected to the battery sensor,
wherein the fuse frame is connected to the sensing connector.

15. The battery module according to claim 14, wherein the fuse frame is accommodated in a housing which forms an exterior of the sensing connector.

16. The battery module according to claim 15, wherein the top case further comprises a top case sensor opening formed in the top case body, in which the sensing connector is positioned.

17. The battery module according to claim 1, wherein the fuse frame is a circuit board, and connects each of the plurality of fuse segments to the fuse connector.

18. The battery module according to claim 1, wherein two bus bars, which are electrically isolated from the bus bar connector among the plurality of bus bars, form a pair of external terminals connected to an external device.
